(19) United States
(12) Patent Application Publication
(10) Pub. No.: US 2019/0041946 A1
(43) Pub. Date: Feb. 7, 2019

(54) Techniques For Adjusting A Clock Frequency To Change A Power State of Logic Circuits

(71) Applicant: Intel Corporation, Santa Clara, CA (US)

(72) Inventor: Gary Wallichs, San Jose, CA (US)

(73) Assignee: Intel Corporation, Santa Clara, CA (US)

(21) Appl. No.: 16/145,808

(22) Filed: Sep. 28, 2018

(51) Int. Cl. G06F 1/32

(52) U.S. Cl. CPC G06F 1/324; G06F 1/3237

(57) ABSTRACT

A transceiver circuit includes a clock management circuit that generates control signals indicating power state information for logic circuits. The clock management circuit changes the power state information indicated by the control signals based on a change in an indication of a power state that is generated by an external source and that is received in a data stream at the transceiver circuit or based on a change in an amount of data stored in an internal queue. The transceiver circuit also includes a dynamic clock control circuit that receives the control signals and that generates a clock signal that is provided to the logic circuits. The dynamic clock control circuit adjusts a frequency of the clock signal based on the control signals indicating a change in the power state information generated by the clock management circuit to adjust the power state of the logic circuits.

### FIELD OF THE DISCLOSURE

The present disclosure relates to electronic circuits, and more particularly, to techniques for adjusting a clock frequency to change a power state of logic circuits.

### BACKGROUND

In traditional field programmable gate array (FPGA) designs, high-speed data transmission protocol layers generally use a free running clock signal that is provided by a high-speed input/output interface to time internal protocol layer logic. A version of the free running clock signal (or a frequency related version) is passed along to local and global clock networks in the FPGA configurable logic fabric to time user FPGA dynamic logic elements. Some dynamic data protocols, such as Peripheral Component Interconnect Express (PCI Express), provide a clock signal from the interface to the FPGA clock networks that is a constant frequency equal to the maximum frequency required to synchronize the worst-case traffic/bandwidth.

### BRIEF DESCRIPTION OF THE DRAWINGS

FIG. 1 illustrates an example of power management circuitry that controls a frequency of a clock signal provided to a clock network in an integrated circuit, according to an embodiment.

FIG. 2 illustrates additional details of the phase-locked loop (PLL) circuit and the dynamic clock control circuit (DCCC) of FIG. 1, according to an embodiment.

FIG. 3 illustrates an example of the clock management circuit shown in FIG. 1, according to an embodiment.

FIG. 4 illustrates examples of operations that can be performed to change a frequency of a clock signal to change a power state of logic circuits, according to an embodiment.

FIG. 5 illustrates an exemplary embodiment of a programmable integrated circuit (IC) that may contain embodiments disclosed herein, for example, with respect to FIGS. 1-4.

### DETAILED DESCRIPTION

Modern data centers typically contain many high-performance servers. The power consumption and energy usage costs of these servers are some of the biggest expenses for managing and maintaining data centers. Power management in field programmable gate arrays (FPGAs) has traditionally been an afterthought, because of the complexity of FPGA workload prediction that is the result of the general-purpose nature of an FPGA and the wide variations of FPGA designs and usages. As the deployment of FPGA accelerators continues to grow in data centers, power reduction considerations are becoming a critical area that needs to be addressed.

As discussed above, some data protocols provide a clock signal to the FPGA clock networks that is the maximum frequency for the worst-case traffic/bandwidth, which provides a relatively simple clock signal scheme for user logic, but is not a power sensitive implementation. An FPGA clock network that is large can pay substantial clock tree power dissipation penalties, even when the data protocol hard intellectual property block is in a software power managed, low-activity state.

Previous solutions generally require customers to build any needed dynamic clock gating and phase-locked loop (PLL) frequency changes using soft logic in the FPGA fabric in customized ways. This technique places the burden on FPGA users to understand the FPGA clock networks and to build circuits using soft logic resources to divide and gate clock signals. However, it may be difficult to build reliable glitch-free circuits using configurable FPGA resources. In addition, fabric clock dividers often require clocks networks to use general FPGA routing resources, which are not well-suited for high performance clocking solutions.

According to some embodiments disclosed herein, an integrated circuit includes a clock management circuit and a dynamic clock control circuit. The dynamic clock control circuit generates an output clock signal in response to an input clock signal. The output clock signal is provided to a clock network in the integrated circuit. The clock management circuit controls the dynamic clock control circuit. The clock management circuit controls a power state for circuitry in the integrated circuit that receives the output clock signal through the clock network. The power state is determined based on the transmission of data between the integrated circuit and an external source. The clock management circuit causes the dynamic clock control circuit to adjust a frequency of the output clock signal relative to the frequency of the input clock signal based on a change in the power state.

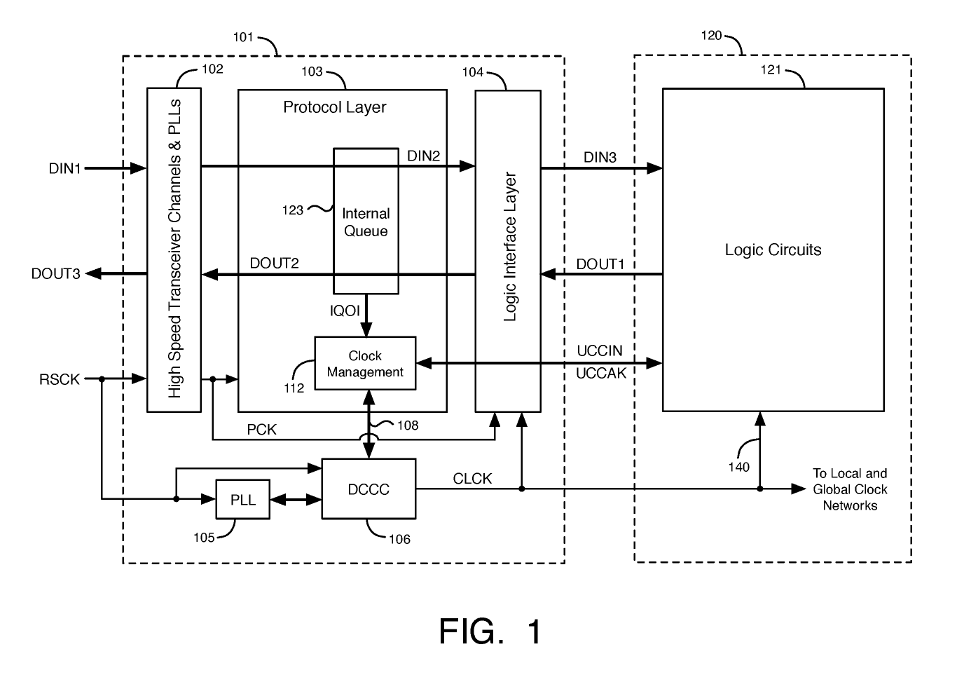

FIG. 1 illustrates an example of power management circuitry that controls a frequency of a clock signal provided to a clock network in an integrated circuit, according to an embodiment. Figure (FIG. 1 shows an interface circuit 101 and core circuitry 120. Interface circuit 101 includes high speed transceiver channels and phase-locked loops (PLLs) circuitry 102, protocol layer circuitry 103, logic interface layer circuit 104, phase-locked loop (PLL) circuit 105, and dynamic clock control circuit (DCCC) 106. Core circuitry 120 includes logic circuits 121 and clock networks, including global and local clock networks. Interface circuit 101 is also referred to as a transceiver circuit.

Interface circuit 101 and core circuitry 120 may be in the same integrated circuit (IC) or in two separate integrated circuits (ICs). If interface circuit 101 and circuitry 120 are both in the same IC, the IC may be, for example, a programmable logic IC, such as an FPGA, a microprocessor or central processing unit (CPU) IC, or a graphics processing unit (GPU) IC. If interface circuit 101 and core circuitry 120 are in separate ICs, interface circuit 101 may, for example, be in a transceiver IC, and core circuitry 120 may, for example, be in a CPU, FPGA, or GPU.

Interface circuit 101 transmits data between an external source and logic circuits 121 in core circuitry 120. The external source may be, for example, another IC such as a CPU or microprocessor. Interface circuit 101 receives input data in a serial or parallel data stream indicated by signals DIN1 at circuitry 102 using a reference source clock signal RSCK. Clock signal RSCK is received from the external source. Circuitry 102 generates a protocol clock signal PCK in response to clock signal RSCK using a PLL. Clock signal PCK is provided to protocol layer circuitry 103 and logic interface layer circuit 104.

The input data provided from circuitry 102 is stored in an internal queue 123 in protocol layer circuitry 103 and then provided to logic interface layer circuit 104 as signals DIN2. Logic interface layer circuit 104 provides the input data to logic circuits 121 as signals DIN3. Logic interface layer circuit 104 includes a first-in-first-out (FIFO) circuit that stores the input data received in signals DIN2 at the clock frequency of clock signal PCK and outputs the stored input data in signals DIN3 at the clock frequency of a different clock signal CLCK. Internal queue 123 can, for example, include a FIFO circuit that stores the input data.

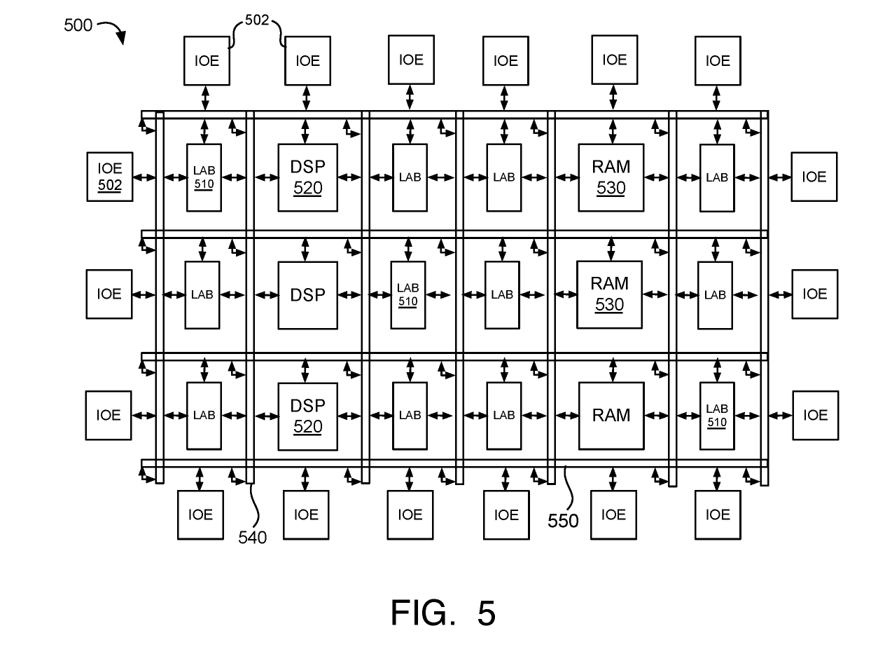

Logic circuits 121 generate output data that is provided to circuit 104 as signals DOUT1. Logic interface layer circuit 104 includes another FIFO circuit that stores the output data received in signals DOUT1 at the clock frequency of clock signal CLCK and outputs the stored output data to the internal queue 123 at the clock frequency of clock signal PCK. The output data is stored in the internal queue 123 in protocol layer circuitry 103 and then provided to circuitry 102 as signals DOUT2. Internal queue 123 can, for example, include another FIFO circuit that stores the output data. Circuitry 102 transmits the output data received in signals DOUT2 to the external source as signals DOUT3 in response to clock signal RSCK. Logic circuits 121 may, for example, include configurable/programmable logic circuits in the core region of an FPGA that are configured according to a user design, as described below with respect to FIG. 5.

Clock signal RSCK is also provided to inputs of PLL 105 and DCCC 106. PLL 105 generates a clock signal and a lock signal that are provided to DCCC 106. DCCC 106 generates an output clock signal CLCK in response to the clock signal generated by PLL 105. Clock signal CLCK is provided to circuit 104, to logic circuits 121 through one or more clock networks 140, and to other global and local clock networks in core circuitry 120.

Protocol layer circuitry 103 includes a clock management circuit 112 that controls a power state of the circuits in circuitry 120 that receive clock signal CLCK, including logic circuits 121. The power state may, for example, be determined based on data in transit between interface circuit 101 and the external source. The clock management circuit 112 causes DCCC 106 to adjust a frequency of output clock signal CLCK in response to a change in the power state.

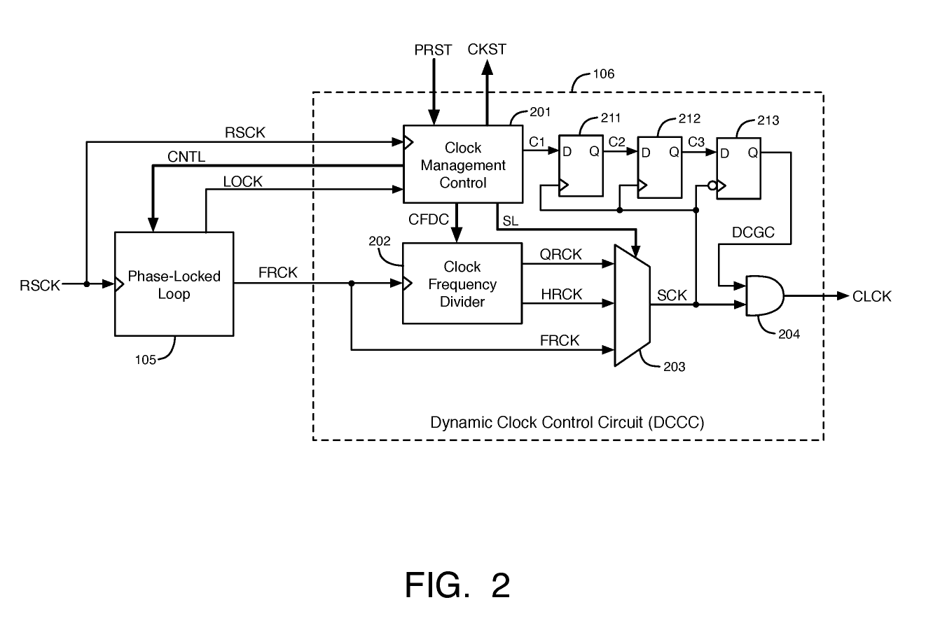

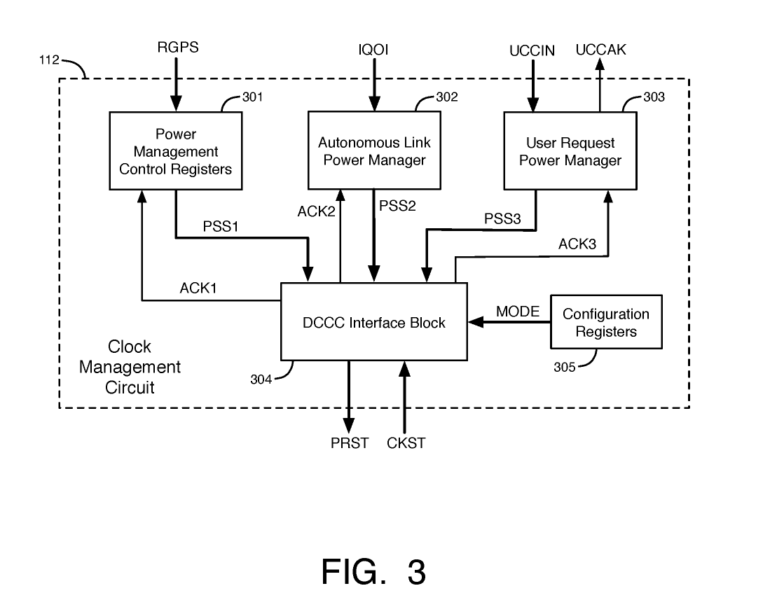

Many high-speed data transmission protocols, such as PCI Express, Ultra-Path Interconnect (UPI), or Universal Serial Bus (USB) have different power states that equate to different levels of power savings in a circuit design. The latency associated with entering into and waking up from a low power state may be different for different types of low power states. For example, a higher power saving state typically requires a longer wake-up latency (e.g., hibernation), compared to a lower power saving state (e.g., stand-by). DCCC 106 can take one of several clock management actions, such as reducing the frequency of clock signal CLCK by one-half or one-quarter, or dynamically gating clock signal CLCK off or back on. As another example, DCCC 106 can reduce the frequency of clock signal CLCK to a lower frequency with a finer granularity of frequency control. The granularity of frequency control for CLCK may depend on the type of frequency controls available in PLL 105. DCCC 106 responds to clock management circuit 112 with appropriate status signals. Further details of PLL 105, DCCC 106, and clock management circuit 112 are disclosed herein with respect to FIGS. 2-3.

FIG. 2 illustrates additional details of the phase-locked loop (PLL) circuit 105 and the dynamic clock control circuit (DCCC) 106 of FIG. 1, according to an embodiment. In the embodiment of FIG. 2, DCCC 106 includes clock management control circuit (CMCC) 201, clock frequency divider (CFD) circuit 202, multiplexer circuit 203, AND logic gate circuit 204, and flip-flop circuits 211-213. PLL 105 generates a clock signal FRCK in response to clock signal RSCK. Clock signal FRCK is provided to an input of CFD circuit 202. PLL 105 also generates a LOCK signal that indicates when clock signal FRCK is in lock with respect to clock signal RSCK. The LOCK signal is provided to an input of CMCC 201. DCCC 106 generates an output clock signal CLCK in response to clock signal FRCK.

DCCC 106 controls the frequency of clock signal CLCK based on a power state of the circuits in circuitry 120 that receive clock signal CLCK. CMCC 201 receives power state control signals PRST from clock management circuit 112 that indicate power state information for the circuits in circuitry 120 that receive clock signal CLCK. Control signals PRST are provided through bus 108, which is shown in FIG. 1. DCCC 106 adjusts the frequency of clock signal CLCK based on changes in the power state information indicated by signals PRST. As an example, DCCC 106 can decrease the frequency of clock signal CLCK based on signals PRST indicating that the circuits in circuitry 120 have changed to a lower power state. The circuits that receive clock signal CLCK may consume less power in response to a lower frequency in CLCK. As another example, DCCC 106 can increase the frequency of clock signal CLCK based on signals PRST indicating that the circuits in circuitry 120 have changed to a higher power state. The circuits that receive clock signal CLCK may consume more power, but operate faster, in response to a higher frequency in CLCK.

CFD circuit 202 divides the frequency of clock signal FRCK by a first frequency divisional value to generate the frequency of a clock signal HRCK. CFD circuit 202 also divides the frequency of clock signal FRCK by a second frequency division value to generate the frequency of a clock signal QRCK. In some embodiments, the first frequency division value is 2, the second frequency division value is 4, and clock signals HRCK and QRCK are half rate and quarter rate clock signals, respectively, with respect to clock signal FRCK. The full rate clock signal FRCK, clock signal HRCK, and clock signal QRCK are provided to three separate multiplexing inputs of multiplexer circuit 203. Multiplexer circuit 203 selects one of these three clock signals as a selected clock signal SCK in response to select signals SL that are generated by CMCC 201. The selected clock signal SCK is provided to a first input of AND gate 204. AND gate 204 generates the output clock signal CLCK at its output.

CMCC 201 generates clock frequency divider control signals CFDC, a clock gate signal C1, PLL control signals CNTL, and the select signals SL based on the power state information indicated by control signals PRST. CMCC 201 is clocked by clock signal RSCK. CMCC 201 controls the frequency of output clock signal CLCK based on the power state information indicated by signals PRST using signals CFDC, C1, CNTL, and SL, as described below.

CMCC 201 sets the logic states of the control signals CFDC, for example, to control the first and second frequency division values of CFD circuit 202 based on the power state information indicated by signals PRST. CMCC 201 can vary signals CFDC to generate different first and second frequency division values of CFD circuit 202 that are used to generate clock signals HRCK and QRCK based on changes in the power state information indicated by signals PRST.

CMCC 201 sets the logic states of the select signals SL based on the power state information indicated by signals PRST to determine which one of the clock signals FRCK, HRCK, or QRCK that multiplexer circuit 203 provides to its output as clock signal SCK. CMCC 201 can vary the logic states of select signals SL based on changes in the power state information indicated by signals PRST to cause multiplexer circuit 203 to provide a different one of the clock signals FRCK, HRCK, or QRCK to its output as clock signal SCK.

DCCC 106 can decrease the frequency of clock signal CLCK in response to signals PRST indicating a lower power state, for example, by causing multiplexer circuit 203 to select a different one of the clock signals FRCK, HRCK, or QRCK that has a lower frequency. Alternatively or in addition, DCCC 106 can decrease the frequency of clock signal CLCK in response to signals PRST indicating a lower power state, for example, by increasing the first or second frequency division values, if multiplexer circuit 203 selects a respective one of clock signals HRCK or QRCK. DCCC 106 can increase the frequency of clock signal CLCK in response to signals PRST indicating a higher power state, for example, by causing multiplexer circuit 203 to select a different one of the clock signals FRCK, HRCK, or QRCK that has a higher frequency. Alternatively or in addition, DCCC 106 can increase the frequency of clock signal CLCK in response to signals PRST indicating a higher power state, for example, by decreasing the first or second frequency division values, if multiplexer circuit 203 selects a respective one of clock signals HRCK or QRCK.

CMCC 201 sets the logic states of the PLL control signals CNTL based on the power state information indicated by signals PRST to determine the ratio of the frequency of clock signal FRCK relative to the frequency of input clock signal RSCK. CMCC 201 can vary the logic states of signals CNTL based on changes in the power state information indicated by signals PRST to cause PLL 105 to vary the frequency of clock signal FRCK. For example, control signals CNTL may control the frequency division values of an output frequency divider circuit and/or a feedback frequency divider circuit in PLL 105. CMCC 201 can increase the frequency of clock signal FRCK using control signals CNTL, for example, by increasing the frequency division value of the feedback frequency divider circuit in PLL 105 and/or by decreasing the frequency division value of the output frequency divider circuit in PLL 105. CMCC 201 can decrease the frequency of clock signal FRCK using control signals CNTL, for example, by increasing the frequency division value of the output frequency divider circuit in PLL 105 and/or by decreasing the frequency division value of the feedback frequency divider circuit in PLL 105. CMCC 201 can vary the ratio of the frequencies of clock signals FRCK and RSCK by changing the frequency division values of one or both of the feedback frequency divider circuit and the output frequency divider circuit in PLL 105. CMCC 201 can also vary the frequency of clock signal CLCK by changing the frequency division values of one or both of the feedback frequency divider circuit and the output frequency divider circuit in PLL 105 and the first or second frequency division value of CFD 202. CMCC 201 can vary the frequency division values of two or more of these frequency divider circuits to increase or decrease the frequency of clock signal CLCK by percentages such as 5%, 10%, 15%, 20%, etc. for different power states.

CMCC 201 also generates a clock gate signal C1 that is used to prevent glitches in clock signal CLCK when DCCC 106 changes the frequency of clock signal CLCK. Signal C1 is provided to the D input of flip-flop circuit 211. The selected clock signal SCK is provided to the clock inputs of flip-flop circuits 211-212 and to the inverting clock input of flip-flop circuit 213. Flip-flop 211 stores the logic state of signal C1 at its Q output in signal C2 in response to each rising edge in clock signal SCK. Flip-flop 212 stores the logic state of signal C2 at its Q output in signal C3 in response to each rising edge in clock signal SCK. Flip-flop circuit 213 stores the logic state of signal C3 at its Q output in signal DCGC in response to each falling edge in clock signal SCK. The dynamic clock gate control signal DCGC is provided to the second input of AND gate circuit 204.

CMCC 201 generates a logic low pulse in signal C1 each time that DCCC 106 changes the frequency of clock signal CLCK to prevent glitches in clock signal CLCK. The logic low pulse in signal C1 propagates through flip-flop circuits 211-213 to signal DCGC at the second input of AND gate circuit 204 after two and a half periods of clock signal SCK. AND gate circuit 204 holds clock signal CLCK in a logic low state for the duration of the logic low pulse in signal DCGC in order to prevent a glitch in clock signal SCK from propagating to clock signal CLCK.

DCCC 106 can also gate the clock signal CLCK off based on signals PRST indicating a power off state for the circuits that receive clock signal CLCK. CMCC 201 can gate the clock signal CLCK off by maintaining signal C1 in a logic low state during the power off state. The logic low state in signal C1 propagates through flip-flop circuits 211-213 and the AND logic gate circuit 204 to signals C2-C3 and DCGC and to clock signal CLCK. Clock signal CLCK remains in a logic low state (i.e., is gated off) for as long as signal DCGC remains in a logic low state. DCCC 106 can turn clock signal CLCK back on by de-asserting signals C1-C3 and DCGC back to logic high states.

Table 1 below shows examples of power states, corresponding exemplary values for the signals PRST that indicate these power states, and corresponding frequencies of clock signal CLCK that occur in response to these values of signals PRST.

TABLE 1

| | Value of | |
|---|---|---|
| Power State | Signals PRST | Frequency of Clock Signal CLCK |
| Active State | 00b | Full-rate frequency - FRCK |
| Stand-by State | 01b | Half-rate frequency - HRCK |
| Sleep State | 10b | Quarter-rate frequency - QRCK |
| Hibernation State | 11b | Gate off clock signal CLCK |

CMCC 201 also generates clock status signals CKST, which are provided through signal lines 108 to clock management circuit 112. CMCC 201 causes signals CKST to indicate the status of a change in the frequency of clock signal CLCK that occurs based on each change in the power state information indicated by signals PRST. As an example, CMCC 201 may adjust one or more of signals CKST to indicate when the clock frequency of clock signal CLCK has changed in response to a corresponding change in the power state information indicated by signals PRST. As another example, CMCC 201 can de-assert one of signals CKST in response to the LOCK signal indicating that PLL 105 is out of lock, and then re-assert that one of signals CKST in response to the LOCK signal indicating that PLL 105 is in lock again. As yet another example, CMCC 201 can adjust one or more of signals CKST to indicate when clock signal CLCK is gated off.

FIG. 3 illustrates an example of the clock management circuit 112 shown in FIG. 1, according to an embodiment. In the embodiment of FIG. 3, the clock management circuit (CMC) 112 includes power management control registers 301, autonomous link power manager circuitry 302, user request power manager circuitry 303, DCCC interface block 304, and configuration registers 305. CMC 112 receives 3 sets of signals RGPS, IQOI, and UCCIN. CMC 112 generates the power state signals PRST based on these 3 sets of signals, as described in detail below.

Many input/output interface protocols such as PCI Express (PCIe) and UPI support power management and low power states using either a hardware autonomous mechanism (e.g., PCIe Active State Power Management) or through software initiated means. These protocol specific power management features provide an indication of changing workloads, and can be used to dynamically control clocking for dynamic power reduction in core circuitry 120. Power state information for the different power states supported by these protocols can be generated by an external source, within protocol layer 103 (e.g., using autonomous link power manager 302), or by logic circuits 121.

Power control signals RGPS indicate a power state generated by the external source that transmits the data stream indicated by signals DIN1. The external source generates the power state, encodes the power state, and transmits the encoded power state in the data stream indicated by signals DIN1. Signals DIN1 may, for example, include the power state encoded in the header of one or more packets. A decoder in protocol layer 103 decodes the encoded power state in signals DIN2 to generate a decoded power state. Power control signals RGPS indicate the power state decoded by the decoder. Power management control registers 301 receive power control signals RGPS at inputs. The power management control registers 301 store the power state indicated by signals RGPS. The power state information stored in power management control registers 301 is provided to DCCC interface block 304 in signals PSS1.

The external source can change the power state indicated by signals DIN1 at any time to indicate a lower power state or a higher power state. For example, if the data rate of the data indicated by signals DIN1 decreases, the external source may cause signals DIN1 to indicate a lower power state. As another example, if the data rate of the data indicated by signals DIN1 increases, the external source may cause signals DIN1 to indicate a higher power state. If signals DIN1/DIN2 indicate a new power state, the decoder in protocol layer 103 decodes the new power state received in signals DIN2 and provides the decoded new power state to power management control registers 301 in signals RGPS. Power management control registers 301 store the new power state indicated by signals RGPS and provide the new power state to DCCC interface block 304 in signals PSS1.

In the embodiment of FIG. 3, the data indicated by signals DIN2 and/or DOUT2 are stored in the internal queue 123 in protocol layer 103 as the data is in transit between the transceiver channels 102 and logic circuits 121. The internal queue occupancy information (IQOI) signals indicate the amount of data stored in the internal queue 123. Signals IQOI are provided from internal queue 123 to inputs of autonomous link power manager 302. Autonomous link power manager 302 autonomously generates power state information based on the internal queue occupancy information indicated by signals IQOI (i.e., the amount of data stored in the internal queue 123). Autonomous link power manager 302 can generate the power state information based on signals IQOI without additional input from the external source or from logic circuits 121.

Autonomous link power manager 302 generates output signals PSS2 that indicate the power state information generated based on signals IQOI. Autonomous link power manager 302 can change the power state information indicated by signals PSS2, for example, based on changes in the amount of data stored in the internal queue 123. If, for example, signals IQOI indicate that the internal queue 123 is storing less data during a lower data rate, autonomous link power manager 302 can cause signals PSS2 to indicate a lower power state or lower clock frequency for CLCK. If, for example, signals IQOI indicate that the internal queue 123 is storing more data during a higher data rate, autonomous link power manager 302 can cause signals PSS2 to indicate a higher power state or higher frequency for CLCK. Signals PSS2 are provided to inputs of DCCC interface block 304.

User clock change signals UCCIN are generated by logic circuits 121 and provided to CMC 112 through signal lines shown in FIG. 1. User request power manager 303 receives signals UCCIN from logic circuits 121. Logic circuits 121 may, for example, cause signals UCCIN to indicate a power state change request, a new clock frequency for clock signal CLCK, a change to the frequency of CLCK (e.g., to reduce the frequency of CLCK by 10%, 20%, 25%, etc.), and/or a new power state for logic circuits 121. Logic circuits 121 can, for example, assert a power state change request bit in signals UCCIN to indicate that logic circuits 121 are changing to a new power state. Logic circuits 121 can initiate a power state change request, for example, in response to a change in a data rate of the data transmitted in signals DIN3 and DOUT1. Logic circuits 121 can adjust additional bits in signals UCCIN to indicate a clock frequency for clock signal CLCK during the new power state. User request power manager 303 generates output signals PSS3 based on the power state information indicated by user clock change signals UCCIN. Signals PSS3 indicate the power state information, such as the new power state and/or a clock frequency for clock signal CLCK during the new power state. Signals PSS3 are provided to inputs of DCCC interface block 304.

Configuration registers 305 store MODE bits. The MODE bits stored in configuration registers 305 are set to one of 3 different values that indicate which of the three sets of signals PSS1, PSS2, or PSS3 DCCC interface block 304 uses to generate signals PRST. Signals PRST are used to set the clock frequency of clock signal CLCK, as discussed above. Thus, the MODE bits stored in the configuration registers 305 indicate whether to set the frequency of clock signal CLCK based on the power state information indicated by signals RGPS, the internal queue occupancy information (IQOI) signals, or the user clock change signals UCCIN. The MODE bits can be provided to the configuration registers 305 from an external source or generated internally within interface circuit 101. The MODE bits are provided to DCCC interface block 304 as MODE signals.

DCCC interface block 304 generates the power state control signals PRST based on the one set of the three sets of signals PSS1, PSS2, or PSS3 that is identified by the MODE signals. Thus, if the MODE signals indicate to use the power state information indicated by signals RGPS, then DCCC interface block 304 causes signals PRST to indicate power state information based on signals PSS1. If the MODE signals indicate to use the power state information generated by the autonomous link power manager 302 based on signals IQOI, then DCCC interface block 304 causes signals PRST to indicate power state information based on signals PSS2. If the MODE signals indicate to use the power state information generated based on the user clock change signals UCCIN, then DCCC interface block 304 causes signals PRST to indicate power state information based on signals PSS3. Signals PRST may, for example, indicate a power state or a clock frequency for clock signal CLCK during a power state. Signals PRST are provided to DCCC 106. DCCC 106 controls the clock frequency of clock signal CLCK based on signals PRST, as described above with respect to FIGS. 1-2.

DCCC interface block 304 varies signals PRST based on changes in the power state information indicated by the set of power state signals (PSS1, PSS2, or PSS3) identified by the MODE signals. For example, if the MODE signals identify signals PSS2, and autonomous link power manager 302 changes the power state information indicated by signals PSS2, then DCCC interface block 304 adjusts signals PRST based on the new power state information indicated by signals PSS2. DCCC interface block 304 also varies signals PRST based on changes in the MODE signals. As an example, if the MODE signals are changed from a value that identifies signals PSS1 to a value that identifies signals PSS3, then DCCC interface block 304 adjusts signals PRST based on the power state information indicated by signals PSS3.

The clock status signals CKST generated by CMCC 201 are provided to inputs of DCCC interface block 304. DCCC interface block 304 outputs clock acknowledgement signals ACK1, ACK2, and/or ACK3 to circuits 301-303, respectively. DCCC interface block 304 asserts a corresponding one of the clock acknowledgement signals ACK1, ACK2, or ACK3 in response to the clock status signals CKST indicating a change in clock signal CLCK that was made based on a respective set of signals PSS1, PSS2, or PSS3. For example, if DCCC 106 changes the frequency of clock signal CLCK in response to new power state information being generated in signals PSS3 and PRST, then DCCC interface block 304 subsequently asserts signal ACK3 in response to signals CKST indicating that the frequency of clock signal CLCK has been changed. User request power manager 303 can then assert a user clock change acknowledgement signal UCCAK in response to signal ACK3 being asserted. Signal UCCAK is provided to logic circuits 121, as shown in FIG. 1, to indicate that the frequency of clock signal CLCK has changed. Logic circuits 121 then respond to signal UCCAK being asserted by making appropriate changes in their operation.

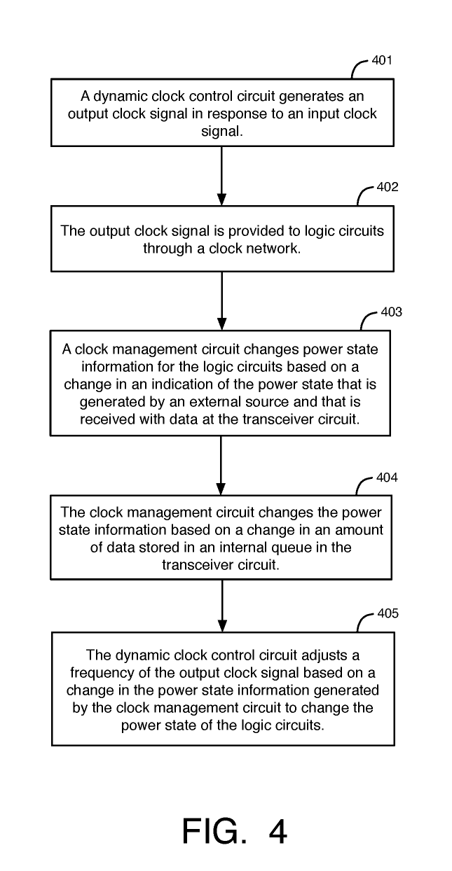

FIG. 4 illustrates examples of operations that can be performed to change a frequency of a clock signal in order to change a power state of logic circuits, according to an embodiment. In operation 401, dynamic clock control circuit 106 generates an output clock signal CLCK in response to an input clock signal FRCK. In operation 402, the output clock signal CLCK is provided to logic circuits 121 through a clock network. In operation 403, clock management circuit 112 changes power state information for the logic circuits 121 based on a change in an indication of the power state that is generated by an external source and that is received with data at the transceiver circuit 101. In operation 404, clock management circuit 112 changes the power state information based on a change in an amount of data stored in internal queue 123 in the transceiver circuit 101. The data stored in the internal queue 123 is in transit between the external source and the logic circuits 121. In operation 405, the dynamic clock control circuit 106 adjusts a frequency of the output clock signal CLCK based on a change in the power state information generated by the clock management circuit to change the power state of the logic circuits 121.

FIG. 5 illustrates an exemplary embodiment of a programmable integrated circuit (IC) 500 that may contain embodiments disclosed herein, for example, with respect to FIGS. 1-4. In some exemplary embodiments, interface circuit 101 and core circuitry 120 are in a single programmable IC 500. In other exemplary embodiments, interface circuit 101 is in a transceiver IC, and core circuitry 120 (and possibly other circuitry) is in a programmable IC 500 (or another type of IC).

As shown in FIG. 5, the programmable integrated circuit (IC) 500 may include a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 may include smaller configurable regions (e.g., logic elements, logic blocks, or adaptive logic modules) that receive input signals and perform custom functions on the input signals to produce output signals. Logic circuits 121 of FIG. 1 may include, for example, LABs 510, DSP blocks 520, and/or RAM blocks 530.

In addition, programmable IC 500 may have input/output elements (IOEs) 502 for driving signals off of programmable IC 500 and for receiving signals from other devices. Input/output elements 502 may include parallel input/output circuitry, serial data transceiver circuitry, differential receiver and transmitter circuitry, or other circuitry used to connect one integrated circuit to another integrated circuit. As shown, input/output elements 502 may be located around the periphery of the chip. If desired, the programmable IC 500 may have input/output elements 502 arranged in different ways. For example, input/output elements 502 may form one or more columns, rows, or islands of input/output elements that may be located anywhere on the programmable IC 500.

The programmable IC 500 may also include programmable interconnect circuitry in the form of vertical routing channels 540 (i.e., interconnects formed along a vertical axis of programmable IC 500) and horizontal routing channels 550 (i.e., interconnects formed along a horizontal axis of programmable IC 500), each routing channel including at least one track to route at least one wire.

Note that other routing topologies, besides the topology of the interconnect circuitry depicted in FIG. 5, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-4 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable IC 500 may contain programmable memory elements. Memory elements may be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable IC 500 may include configuration memory that is organized in sectors, whereby a sector may include the configuration RAM bits that specify the functions and/or interconnections of the subcomponents and wires in or crossing that sector. Each sector may include separate data and address registers.

The programmable IC of FIG. 5 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

The following examples pertain to further embodiments. Example 1 is an integrated circuit comprising a transceiver circuit, wherein the transceiver circuit comprises: a clock management circuit that generates control signals indicating power state information for logic circuits, wherein the clock management circuit is adapted to change the power state information indicated by the control signals based on a change in an indication of a power state that is generated by an external source outside the integrated circuit and that is received in a data stream at the transceiver circuit, wherein the clock management circuit is adapted to change the power state information indicated by the control signals based on a change in an amount of data stored in an internal queue, and wherein the data stored in the internal queue is in transit between the external source and the logic circuits; and a dynamic clock control circuit that receives the control signals and that generates a clock signal, wherein the clock signal is provided to the logic circuits, and wherein the dynamic clock control circuit adjusts a frequency of the clock signal based on the control signals indicating a change in the power state information generated by the clock management circuit to adjust the power state of the logic circuits.

In Example 2, the integrated circuit of Example 1 can optionally include wherein the clock management circuit comprises: power management control registers that store signals that indicate the power state received from the external source that exchanges the data with the integrated circuit; and an interface circuit that generates the control signals based on the signals stored in the power management control registers.

In Example 3, the integrated circuit of any one of Examples 1-2 can optionally further include wherein the clock management circuit comprises: an autonomous link power manager that generates the power state information based on the amount of data stored in the internal queue.

In Example 4, the integrated circuit of any one of Examples 1-3 can optionally further include wherein the clock management circuit is adapted to change the power state information indicated by the control signals based on a change in additional power state information indicated by user signals that are generated by the logic circuits and transmitted to the clock management circuit, and wherein the integrated circuit is a programmable logic integrated circuit.

In Example 5, the integrated circuit of Example 4 can optionally include wherein the clock management circuit comprises: a user request power manager that generates power state signals based on the additional power state information indicated by the user signals that are generated by the logic circuits; and an interface circuit that generates the power state information in the control signals based on the power state signals.

In Example 6, the integrated circuit of any one of Examples 1-5 can optionally further include wherein the dynamic clock control circuit comprises: a clock management control circuit that generates additional control signals based on the control signals received from the clock management circuit; a clock frequency divider circuit that generates a frequency divided clock signal in response to an input clock signal; and a multiplexer circuit that selects one of the frequency divided clock signal or the input clock signal in response to the additional control signals.

In Example 7, the integrated circuit of any one of Examples 1-6 can optionally include wherein the transceiver circuit further comprises: a phase-locked loop circuit, wherein the dynamic clock control circuit comprises a clock management control circuit that generates additional control signals based on the power state information indicated by the control signals received from the clock management circuit, wherein the phase-locked loop circuit adjusts a frequency of an additional clock signal based on changes in the additional control signals, and wherein the dynamic clock control circuit generates the clock signal in response to the additional clock signal.

In Example 8, the integrated circuit of any one of Examples 1-7 can optionally further include, wherein the dynamic clock control circuit comprises: a clock management control circuit that generates an additional control signal based on the power state information indicated by the control signals received from the clock management circuit; flip-flop circuits that store a logic state of the additional control signal; and a logic gate circuit that is coupled to gate the clock signal on or off in response to the logic state of the additional control signal as received through the flip-flop circuits.

In Example 9, the integrated circuit of any one of Examples 1-8 can optionally further include wherein the clock management circuit changes the power state information in response to a change in a data rate of the data in transit between the logic circuits and an external source.

Example 10 is an electronic system comprising: logic circuits; and a transceiver circuit, wherein the transceiver circuit comprises: a clock management circuit that generates power state information for the logic circuits, wherein the clock management circuit changes the power state information based on a change in an indication of a power state that is generated by an external source outside the transceiver circuit and that is received in a data stream at the transceiver circuit, wherein the clock management circuit changes the power state information based on a change in an amount of data stored in an internal queue in the transceiver circuit, and wherein the data stored in the internal queue is in transit between the external source and the logic circuits; and a dynamic clock control circuit that generates an output clock signal in response to an input clock signal, wherein the electronic system provides the output clock signal to the logic circuits, and wherein the dynamic clock control circuit adjusts a frequency of the output clock signal based on a change in the power state information generated by the clock management circuit to cause a change in the power state of the logic circuits.

In Example 11, the electronic system of Example 10 can optionally include wherein the clock management circuit comprises: power management control registers that receive and store signals that indicate the power state from the external source, wherein the power state information is generated based on the signals stored in the power management control registers.

In Example 12, the electronic system of any one of Examples 10-11 can optionally include wherein the clock management circuit comprises: an autonomous link power manager that generates the power state information based on the amount of the data stored in the internal queue.

In Example 13, the electronic system of any one of Examples 10-12 can optionally include wherein the clock management circuit comprises: a user request power manager that receives signals from the logic circuits that indicate the power state information for the logic circuits, wherein the logic circuits are configurable logic circuits in a programmable logic integrated circuit.

In Example 14, the electronic system of any one of Examples 10-13 can optionally include wherein the dynamic clock control circuit comprises: a clock management control circuit that generates control signals based on the power state information received from the clock management circuit; a clock frequency divider circuit that generates a frequency divided clock signal in response to the input clock signal; and a multiplexer circuit that selects one of the frequency divided clock signal or the input clock signal as the output clock signal in response to the control signals.

In Example 15, the electronic system of any one of Examples 10-14 can optionally include wherein the dynamic clock control circuit comprises: a clock management control circuit that generates a control signal based on the power state information received from the clock management circuit; flip-flop circuits that store a logic state of the control signal; and a logic gate circuit that is coupled to gate the output clock signal on or off in response to the logic state of the control signal provided through the flip-flop circuits.

Example 16 is a method for changing a frequency of a clock signal to change a power state of logic circuits, the method comprising: generating an output clock signal in response to an input clock signal using a dynamic clock control circuit in a transceiver circuit; providing the output clock signal to the logic circuits through a clock network; changing power state information for the logic circuits using a clock management circuit in the transceiver circuit based on a change in an indication of the power state that is generated by an external source and that is received with data at the transceiver circuit; changing the power state information using the clock management circuit based on a change in an amount of data stored in an internal queue in the transceiver circuit, wherein the data stored in the internal queue is in transit between the external source and the logic circuits; and adjusting a frequency of the output clock signal based on a change in the power state information generated by the clock management circuit to change the power state of the logic circuits using the dynamic clock control circuit.

In Example 17, the method of Example 16 can optionally include wherein changing the power state information using the clock management circuit based on a change in the amount of data stored in the internal queue in the transceiver circuit comprises changing the power state information in response to a change in a data rate of data in transit between the logic circuits and the external source.

In Example 18, the method of any one of Examples 16-17 can optionally include wherein changing the power state information for the logic circuits using the clock management circuit in the transceiver circuit based on a change in the indication of the power state that is generated by the external source and that is received with data at the transceiver circuit comprises receiving and storing signals that indicate the power state from the external source in power management control registers in the clock management circuit, and changing the power state information based on a change in the signals stored in the power management control registers.

In Example 19, the method of any one of Examples 16-18 can optionally include wherein changing the power state information using the clock management circuit based on a change in the amount of data stored in the internal queue in the transceiver circuit comprises changing the power state information based on the amount of data stored in the internal queue using an autonomous link power manager in the clock management circuit.

In Example 20, the method of any one of Examples 16-19 can optionally further include changing the power state information using a user request power manager in the clock management circuit based on a change in additional power state information indicated by user signals that are generated by the logic circuits and transmitted to the clock management circuit.

Although the method operations were described in a specific order, it should be understood that other operations may be performed in between described operations, described operations may be adjusted so that they occur at different times or in a different order, or described operations may be distributed in a system that allows the occurrence of the operations at various intervals associated with the processing.

The foregoing description of the exemplary embodiments of the present invention has been presented for the purpose of illustration. The foregoing description is not intended to be exhaustive or to limit the present invention to the examples disclosed herein. In some instances, some features of the present invention can be employed without a corresponding use of other features as set forth. Many modifications, substitutions, and variations are possible in light of the above teachings, without departing from the scope of the present invention.

What is claimed is:

1. An integrated circuit comprising a transceiver circuit, wherein the transceiver circuit comprises:
a clock management circuit that generates control signals indicating power state information for logic circuits, wherein the clock management circuit is adapted to change the power state information indicated by the control signals based on a change in an indication of a power state that is generated by an external source outside the integrated circuit and that is received in a data stream at the transceiver circuit, wherein the clock management circuit is adapted to change the power state information indicated by the control signals based on a change in an amount of data stored in an internal queue, and wherein the data stored in the internal queue is in transit between the external source and the logic circuits; and
a dynamic clock control circuit that receives the control signals and that generates a clock signal, wherein the clock signal is provided to the logic circuits, and wherein the dynamic clock control circuit adjusts a frequency of the clock signal based on the control signals indicating a change in the power state information generated by the clock management circuit to adjust the power state of the logic circuits.

2. The integrated circuit of claim 1, wherein the clock management circuit comprises:
power management control registers that store signals that indicate the power state received from the external source that exchanges the data with the integrated circuit; and
an interface circuit that generates the control signals based on the signals stored in the power management control registers.

3. The integrated circuit of claim 1, wherein the clock management circuit comprises:
an autonomous link power manager that generates the power state information based on the amount of data stored in the internal queue.

4. The integrated circuit of claim 1, wherein the clock management circuit is adapted to change the power state information indicated by the control signals based on a change in additional power state information indicated by user signals that are generated by the logic circuits and transmitted to the clock management circuit, and wherein the integrated circuit is a programmable logic integrated circuit.

5. The integrated circuit of claim 4, wherein the clock management circuit comprises:
a user request power manager that generates power state signals based on the additional power state information indicated by the user signals that are generated by the logic circuits; and
an interface circuit that generates the power state information in the control signals based on the power state signals.

6. The integrated circuit of claim 1, wherein the dynamic clock control circuit comprises:
a clock management control circuit that generates additional control signals based on the control signals received from the clock management circuit;
a clock frequency divider circuit that generates a frequency divided clock signal in response to an input clock signal; and
a multiplexer circuit that selects one of the frequency divided clock signal or the input clock signal in response to the additional control signals.

7. The integrated circuit of claim 1, wherein the transceiver circuit further comprises:
a phase-locked loop circuit, wherein the dynamic clock control circuit comprises a clock management control circuit that generates additional control signals based on the power state information indicated by the control signals received from the clock management circuit, wherein the phase-locked loop circuit adjusts a frequency of an additional clock signal based on changes in the additional control signals, and wherein the dynamic clock control circuit generates the clock signal in response to the additional clock signal.

8. The integrated circuit of claim 1, wherein the dynamic clock control circuit comprises:
a clock management control circuit that generates an additional control signal based on the power state information indicated by the control signals received from the clock management circuit;
flip-flop circuits that store a logic state of the additional control signal; and
a logic gate circuit that is coupled to gate the clock signal on or off in response to the logic state of the additional control signal as received through the flip-flop circuits.

9. The integrated circuit of claim 1, wherein the clock management circuit changes the power state information in response to a change in a data rate of the data in transit between the logic circuits and an external source.

10. An electronic system comprising:
logic circuits; and
a transceiver circuit, wherein the transceiver circuit comprises:
a clock management circuit that generates power state information for the logic circuits, wherein the clock management circuit changes the power state information based on a change in an indication of a power state that is generated by an external source outside the transceiver circuit and that is received in a data stream at the transceiver circuit, wherein the clock management circuit changes the power state information based on a change in an amount of data stored in an internal queue in the transceiver circuit, and wherein the data stored in the internal queue is in transit between the external source and the logic circuits; and
a dynamic clock control circuit that generates an output clock signal in response to an input clock signal, wherein the electronic system provides the output clock signal to the logic circuits, and wherein the dynamic clock control circuit adjusts a frequency of the output clock signal based on a change in the power state information generated by the clock management circuit to cause a change in the power state of the logic circuits.

11. The electronic system of claim 10, wherein the clock management circuit comprises:
power management control registers that receive and store signals that indicate the power state from the external source, wherein the power state information is generated based on the signals stored in the power management control registers.

12. The electronic system of claim 10, wherein the clock management circuit comprises:
an autonomous link power manager that generates the power state information based on the amount of the data stored in the internal queue.

13. The electronic system of claim 10, wherein the clock management circuit comprises:
a user request power manager that receives signals from the logic circuits that indicate the power state information for the logic circuits, wherein the logic circuits are configurable logic circuits in a programmable logic integrated circuit.

14. The electronic system of claim 10, wherein the dynamic clock control circuit comprises:
a clock management control circuit that generates control signals based on the power state information received from the clock management circuit;
a clock frequency divider circuit that generates a frequency divided clock signal in response to the input clock signal; and
a multiplexer circuit that selects one of the frequency divided clock signal or the input clock signal as the output clock signal in response to the control signals.

15. The electronic system of claim 10, wherein the dynamic clock control circuit comprises:
a clock management control circuit that generates a control signal based on the power state information received from the clock management circuit;
flip-flop circuits that store a logic state of the control signal; and
a logic gate circuit that is coupled to gate the output clock signal on or off in response to the logic state of the control signal provided through the flip-flop circuits.

16. A method for changing a frequency of a clock signal to change a power state of logic circuits, the method comprising:
generating an output clock signal in response to an input clock signal using a dynamic clock control circuit in a transceiver circuit;
providing the output clock signal to the logic circuits through a clock network;
changing power state information for the logic circuits using a clock management circuit in the transceiver circuit based on a change in an indication of the power state that is generated by an external source and that is received with data at the transceiver circuit;
changing the power state information using the clock management circuit based on a change in an amount of data stored in an internal queue in the transceiver circuit, wherein the data stored in the internal queue is in transit between the external source and the logic circuits; and
adjusting a frequency of the output clock signal based on a change in the power state information generated by the clock management circuit to change the power state of the logic circuits using the dynamic clock control circuit.

17. The method of claim 16, wherein changing the power state information using the clock management circuit based on a change in the amount of data stored in the internal queue in the transceiver circuit comprises changing the power state information in response to a change in a data rate of the data in transit between the logic circuits and the external source.

18. The method of claim 16, wherein changing the power state information for the logic circuits using the clock management circuit in the transceiver circuit based on a change in the indication of the power state that is generated by the external source and that is received with data at the transceiver circuit comprises receiving and storing signals that indicate the power state from the external source in power management control registers in the clock management circuit, and changing the power state information based on a change in the signals stored in the power management control registers.

19. The method of claim 16, wherein changing the power state information using the clock management circuit based on a change in the amount of data stored in the internal queue in the transceiver circuit comprises changing the power state information based on the amount of data stored in the internal queue using an autonomous link power manager in the clock management circuit.

20. The method of claim 16 further comprising:
changing the power state information using a user request power manager in the clock management circuit based on a change in additional power state information indicated by user signals that are generated by the logic circuits and transmitted to the clock management circuit.
